(19) United States
(12) Patent Application Publication
(10) Pub. No.: US 2025/0175998 A1
(43) Pub. Date: May 29, 2025

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Zhaobang MIAO, Beijing (CN)

(73) Assignee: NEC CORPORATION, Tokyo (JP)

(21) Appl. No.: 18/840,641

(22) PCT Filed: Feb. 22, 2022
(86) PCT No.: PCT/CN2022/077335

§ 371 Date: Aug. 22, 2024

(51) Int. Cl. H04W 72/25; H04W 72/0453

(52) U.S. Cl. CPC H04W 72/25; H04W 72/0453

(57) ABSTRACT

Embodiments of the present disclosure relate to method, device and computer readable media for communications. The method comprises determining, at a terminal device, a sidelink control channel resource based on sidelink resource configuration information, the sidelink control channel resource comprising a first number of frequency resource units, each of the frequency resource units being a resource block (RB) or interlace; and transmitting or receiving sidelink control information on the sidelink control channel resource.

### TECHNICAL FIELD

Embodiments of the present disclosure generally relate to the field of telecommunication, and in particular, to a method, device and computer readable media for sidelink communication.

### BACKGROUND

Sidelink on unlicensed spectrum or band (SL-U) is to be studied in the 3rd Generation Partnership Project (3GPP). The scheme of SL-U should base on New Radio (NR) sidelink and NR on unlicensed spectrum (NR-U). Interlace of resource block (IRB) is used as a frequency resource unit for NR-U uplink. A number of resource blocks (RBs) are configured or pre-configured as a Physical Sidelink Control Channel (PSCCH) resource in NR sidelink.

### SUMMARY

In general, example embodiments of the present disclosure provide methods, devices and computer readable media for communications.

In a first aspect, there is provided a method for communications. The method comprises: determining, at a terminal device, a sidelink control channel resource based on sidelink resource configuration information, the sidelink control channel resource comprising a first number of frequency resource units, each of the frequency resource units being a resource block (RB) or interlace; and transmitting or receiving sidelink control information on the sidelink control channel resource.

In a second aspect, there is provided a terminal device. The terminal device comprises a processor and a memory storing instructions. The memory and the instructions are configured, with the processor, to cause the terminal device to perform the method according to the first aspect.

In a third aspect, there is provided a computer readable medium having instructions stored thereon. The instructions, when executed on at least one processor of a device, cause the device to perform the method according to the first aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of automatic gain control (AGC) symbol and guard period (GP) symbol in accordance with some embodiments of the present disclosure;

FIG. 3 illustrates an example of a PSCCH resource in a frequency resource scheme for sidelink on licensed spectrum in accordance with some embodiments of the present disclosure;

FIG. 4 illustrates an example of IRBs in an NR-U IRB scheme in accordance with some embodiments of the present disclosure;

FIG. 5 illustrates a flowchart of an example method in accordance with some embodiments of the present disclosure;

FIG. 6A to 6E illustrate an example of a sidelink control channel resource in accordance with some embodiments of the present disclosure, respectively;

FIG. 7A to 7F illustrate an example of a sidelink control channel resource in accordance with some embodiments of the present disclosure, respectively;

FIGS. 8A and 8B illustrate an example of a sidelink control channel resource in accordance with some embodiments of the present disclosure, respectively;

FIG. 9A to 9C illustrate an example of mapping of SCI on a sidelink control channel resource in accordance with some embodiments of the present disclosure, respectively; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

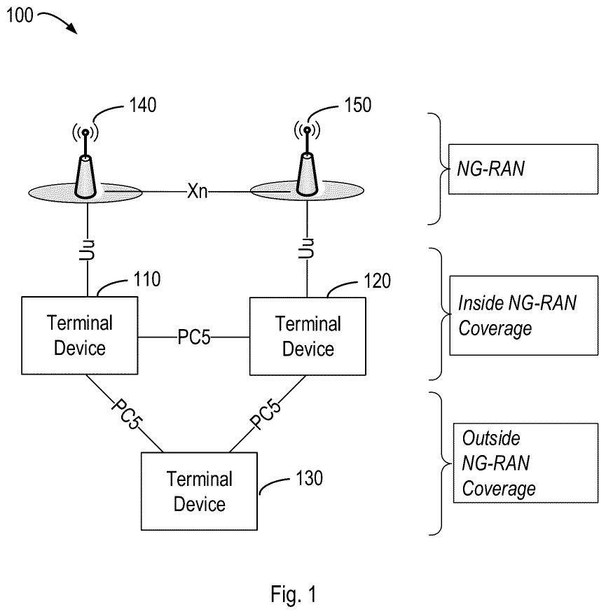

FIG. 1 illustrates a schematic diagram of an example communication network 100 in which embodiments of the present disclosure can be implemented. As shown in FIG. 1, the communication network 100 may include a terminal device 110, a terminal device 120, a terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V21), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

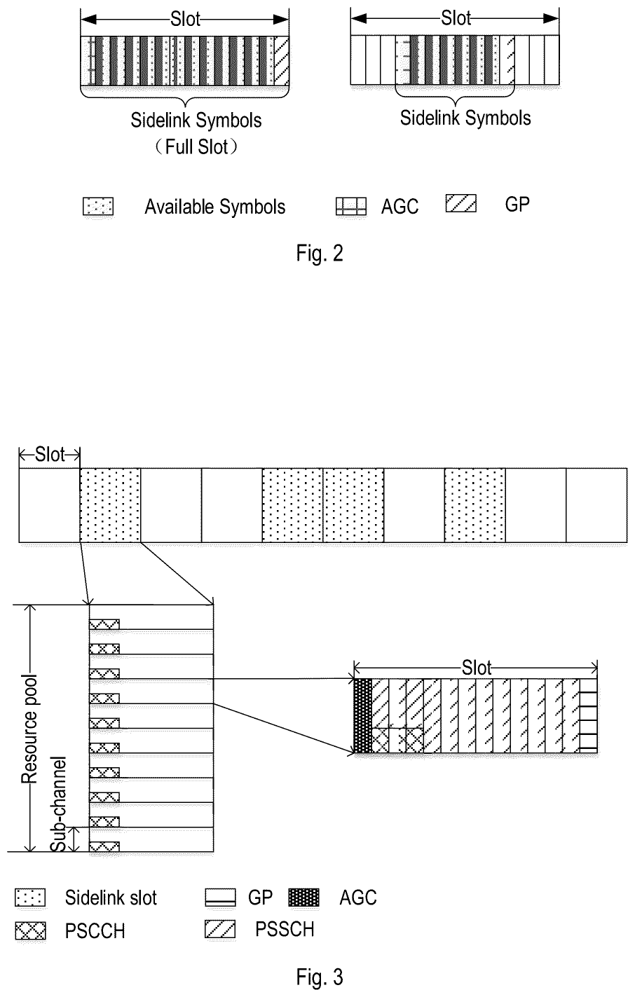

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The terminal device 110, the terminal device 120 and the terminal device 130 may use sidelink channels to transmit sidelink signaling or information. The sidelink channels include at least one of the following: a Physical Sidelink Control Channel (PSCCH) resource which is used for carrying sidelink control information (SCI), a PSSCH resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

As mentioned above, a number of RBs are configured or pre-configured as a PSCCH resource in NR sidelink. FIG. 3 illustrates an example of a PSCCH resource in a frequency resource scheme for sidelink on licensed spectrum in accordance with some embodiments of the present disclosure. As shown in FIG. 3, a resource pool may be configured within a SL Bandwidth Part (BWP). A resource pool configuration may comprise sl-StartRB-Subchannel and sl-RB-Number. The sl-StartRB-Subchannel may indicate the lowest RB of the resource pool. The lowest RB is also referred to as a start RB. The sl-RB-Number may indicate the total number of RBs of the resource pool.

RBs in the resource pool may be divided into consecutive sub-channels. Sub-channel is a frequency resource unit of PSSCH. Each sub-channel contains consecutive RBs. A terminal device may use one or more consecutive sub-channels as a PSSCH resource to transmit sidelink data. A sub-channel configuration of the resource pool may comprise sl-SubchannelSize which indicates the number of RBs contained in one sub-channel. The SubchannelSize may be equal to 10, 12, 15, 20, 25, 50, 75 or 100.

A PSCCH resource may be defined within each sub-channel. Each PSCCH resource may include t consecutive symbols in time domain and k consecutive RBs in frequency domain. The t symbols may start from the first symbol in the available symbols in the time domain. For example, t may be equal to 2 or 3. The k RBs may start from the lowest RB in the corresponding sub-channel. For example, k may be equal to 10, 12, 15, 20, or 25.

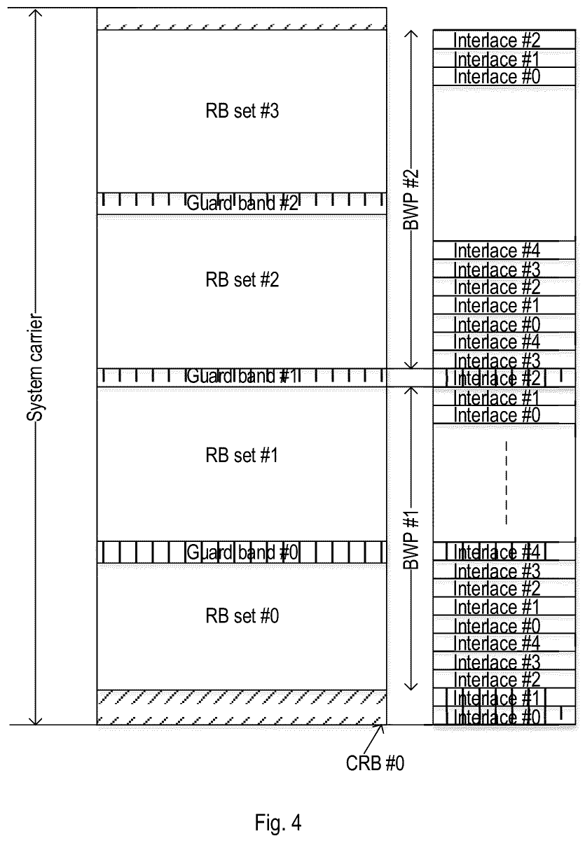

As mentioned above, IRB is used as a frequency resource unit for NR-U uplink. FIG. 4 illustrates an example of an RB set and IRB in an NR-U IRB scheme in accordance with some embodiments of the present disclosure. As shown in FIG. 4, each of the RB sets may be defined as 20 MHz. For Subcarrier Spacing (SCS) of 15 kHz, each of the RB sets may comprises 100 to 110 RBs. For SCS of 30 kHz, each of the RB sets may comprises 50 to 55 RBs. There may be a guard band between two adjacent RB sets.

BWPs #1 and #2 are defined within a system carrier. The BWP #1 comprises RB sets #0 and #1. The BWP #2 comprises RB sets #2 and #3. It will be understood that although it is shown in FIG. 4 that each of BWPs comprises a plurality of RB sets, in some embodiments, one or more of the BWPs may comprise a single RB set.

In the present disclosure, terms “IRB” and “interlace” may be used interchangeably. IRBs or interlaces are defined within a system carrier. An IRB with an index 0 starts from a Common Resource Block (CRB) with an index 0 (i.e., CRB #0). For SCS of 30 kHz, 5 interlaces may be defined within the system carrier, as shown in FIG. 4. For SCS of 15 kHz, 10 interlaces may be defined within the system carrier.

For IRB based sub-channel structure, the PSCCH resource should be defined.

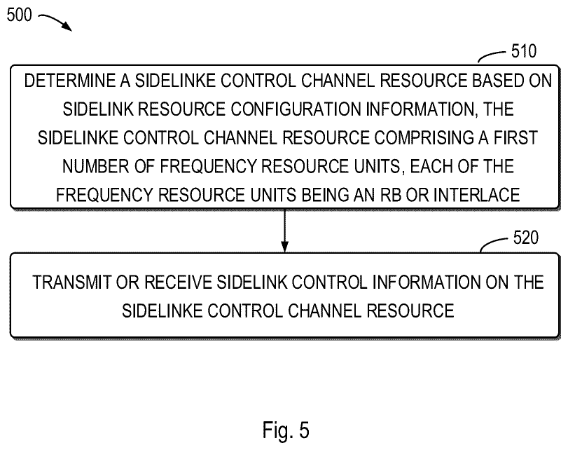

FIG. 5 illustrates a flowchart of an example method 500 in accordance with some embodiments of the present disclosure. In some embodiments, the method 500 can be implemented at a terminal device, such as one of the terminal device 110, the terminal device 120 and the terminal device 130 as shown in FIG. 1. For the purpose of discussion, the method 500 will be described with reference to FIG. 1 as performed by the terminal device 110 without loss of generality.

At block 510, the terminal device 110 determines a sidelink control channel resource based on sidelink resource configuration information. The sidelink control channel resource comprises a first number of frequency resource units. Each of the frequency resource units is an RB or interlace.

At block 520, the terminal device 110 transmits or receives sidelink control information on the sidelink control channel resource.

Hereinafter, embodiments of the present disclosure will be described by taking PSCCH resource as an example of the sidelink control channel resource. The solution of the present disclosure may be used with other sidelink control channel resources than PSCCH. The scope of the present disclosure is not limited in this regard.

It should be understood that it is assumed that the definition of IRB in the NR-U IRB scheme is used in embodiments of the present disclosure. In addition, it should be understood that in embodiments of the present disclosure, it is assumed that a sub-channel resource may be mapped to a second number of IRBs, where the second number is greater than or equal to one. In other words, a sub-channel resource may comprise RBs in the second number of IRBs. The second number of IRBs may be the second number of consecutive or non-consecutive IRBs.

Hereinafter, for brevity, IRB or interlace with an index X is also referred to as IRB #X or interlace #X, and RB with an index Y is also referred to as RB #Y. Similarly, sub-channel with an index Z is also referred to as sub-channel #Z. Each of X, Y and Z is a non-negative integer.

In some embodiments, the sidelink resource configuration information may comprise at least one of the following: a sub-channel resource configuration, or a sidelink control channel resource configuration.

In some embodiments, the terminal device 110 may obtain the sidelink resource configuration information from at least one of following: pre-definition, configuration, or pre-configuration.

In some embodiments, the sidelink control channel resource configuration is for at least one of the following: a sidelink resource pool, a sidelink BWP, a sidelink carrier, or an RB set.

In some embodiments, the sub-channel resource configuration is for at least one of the following: a sidelink resource pool, a sidelink BWP, a sidelink carrier, or an RB set.

In some embodiments, the sub-channel resource configuration indicates at least one of following: a second number of interlaces comprised in a sub-channel resource, or an index of at least one of the second number of interlaces comprised in the sub-channel.

In some embodiments, the sidelink control channel resource configuration indicates at least one of the following:
an interlace enablement indication which indicates using interlace as frequency domain resource unit for the sidelink control channel resource,
a frequency domain resource unit indication which indicates using interlace or RB as frequency domain resource unit for the sidelink control channel resource,
the first number,
a list of available values for the first number,
a third number, the sidelink control channel resource comprising the third number of symbols within a slot, or
a frequency domain location indication of the sidelink control channel resource.

For example, the terminal device 110 may receive, from the network device 140, the sidelink control channel resource configuration through a high layer signaling, and the sidelink control channel resource configuration may comprise at least one of the following:
SL-U-PSCCH-Config:
   sl-U-useinterlacePSCCH
   sl-U-FreqResourceUnitPSCCH
   sl-U-TimeResourcePSCCH
   sl-U-FreqResourcePSCCH
   sl-U-FreqResourcePSCCH-list
   sl-U-FreqResourceAllocationPSCCH
      where:
SL-U-PSCCH-Config represents the sidelink control channel resource configuration;
sl-U-useinterlacePSCCH represents an interlace enablement indication which indicates using interlace as frequency domain resource unit for PSCCH, and if sl-U-useinterlacePSCCH=enable, IRB will be used as the frequency resource unit for PSCCH, otherwise, RB will be used as the frequency resource unit for PSCCH;
sl-U-FreqResourceUnitPSCCH represents a frequency domain resource unit indication which indicates using interlace or RB as frequency domain resource unit for the sidelink control channel resource, and if sl-U-FreqResourceUnitPSCCH=“interlace”, IRB will be used as the frequency resource unit for PSCCH, and if sl-U-FreqResourceUnitPSCCH=“RB”, RB will be used as the frequency resource unit for PSCCH;
sl-U-TimeResourcePSCCH represents the third number;
sl-U-FreqResourcePSCCH represents the first number, and when sl-U-useinterlacePSCCH or sl-U-FreqResourceUnitPSCCH indicates using IRB as frequency domain resource unit for PSCCH, n represents the number of IRBs for each PSCCH resource, otherwise, n represents the number of RBs for each PSCCH resource;
sl-U-FreqResourcePSCCH-list represents a list of available values for the first number; for an embodiment, when IRB is configured as frequency domain resource unit for PSCCH, sl-U-FreqResourcePSCCH-list=[1, 2, 4], i.e., the first number n may be equal to 1, 2, or 4; when RB is configured as frequency domain resource unit for PSCCH, sl-U-FreqResourcePSCCH-list=[8, 10, 15, 20], i.e., the first number n may be equal to 8, 10, 15, 20;
sl-U-FreqResourceAllocationPSCCH represents a frequency domain location indication of the sidelink control channel resource.

In some embodiments, the frequency domain location indication indicates one of the following:
the sidelink control channel resource starts from a lowest interlace in a corresponding sub-channel resource,
the sidelink control channel resource starts from a starting interlace in the corresponding sub-channel resource,
the sidelink control channel resource starts from a lowest RB of the lowest interlace in the corresponding sub-channel resource, or
the sidelink control channel resource starts from a lowest RB of the starting interlace in the corresponding sub-channel resource.

As used herein, the term “lowest interlace” refer to an interlace with a smallest index in a sub-channel, and the term “starting interlace” refer to the first interlace in a sub-channel. In other words, the “starting interlace” refers to the interlace which comprises an RB with a smallest index in the sub-channel. In some embodiments, the “lowest interlace” and the “starting interlace” may refer to a same interlace.

As used herein, the term “lowest RB” refers to an RB with a smallest index in a sub-channel or interlace.

In some embodiments, the sidelink resource configuration information may indicates an interlace enablement indication which indicates using interlace as frequency domain resource unit for sidelink transmission. In some embodiments, the interlace enablement indication may indicate using interlace as frequency domain resource unit for both of the sidelink control channel resource and the sub-channel resource.

Hereinafter, for the purpose of discussion, the first number will be represented by n, the second number will be represented by k, the third number will be represented by t, where each of n and k is a non-negative integer, 2<=t<=T, T represents the number of symbols used for sidelink in a slot.

In some embodiments, the sidelink control channel resource comprises the first number of interlaces, and the first number of interlaces are comprised in a corresponding sub-channel resource. In other words, the sidelink control channel resource is defined within one sub-channel and uses interlace as frequency resource unit.

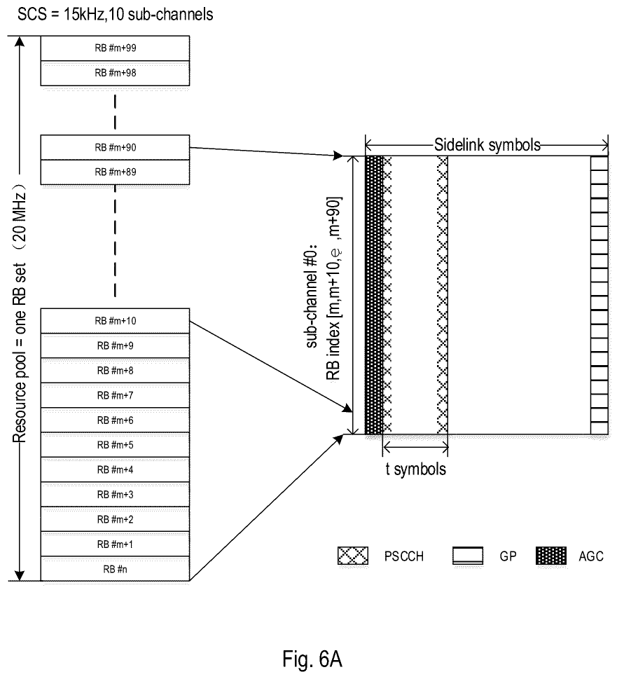

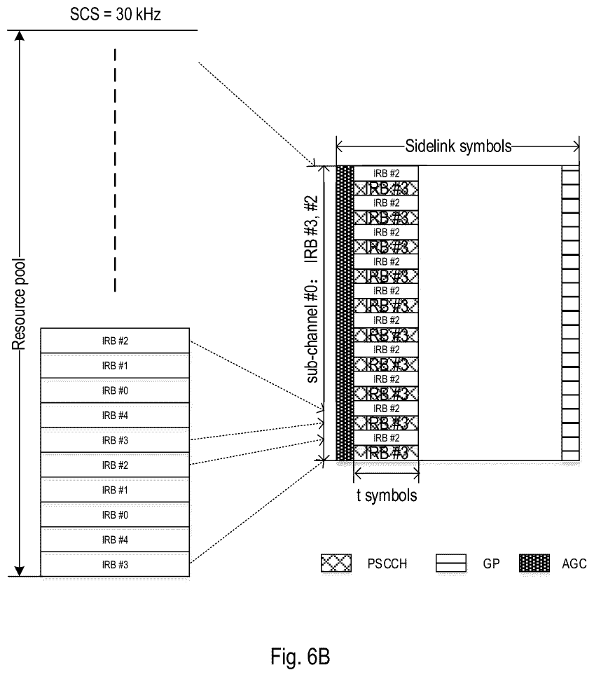

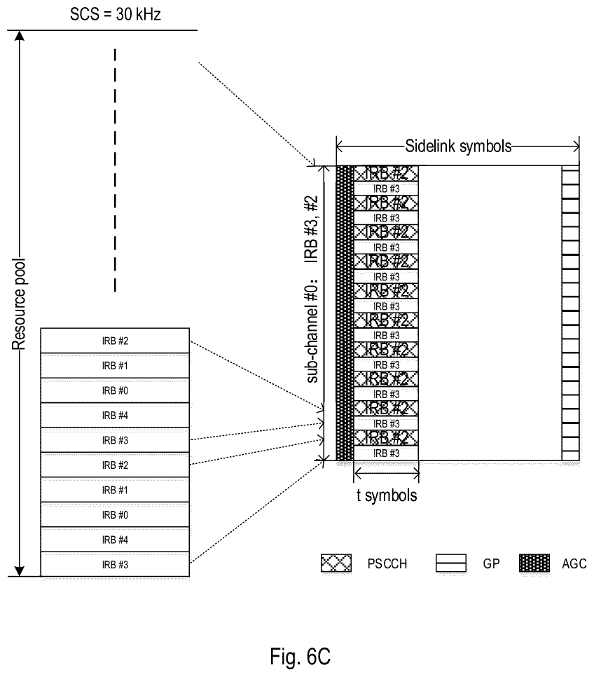

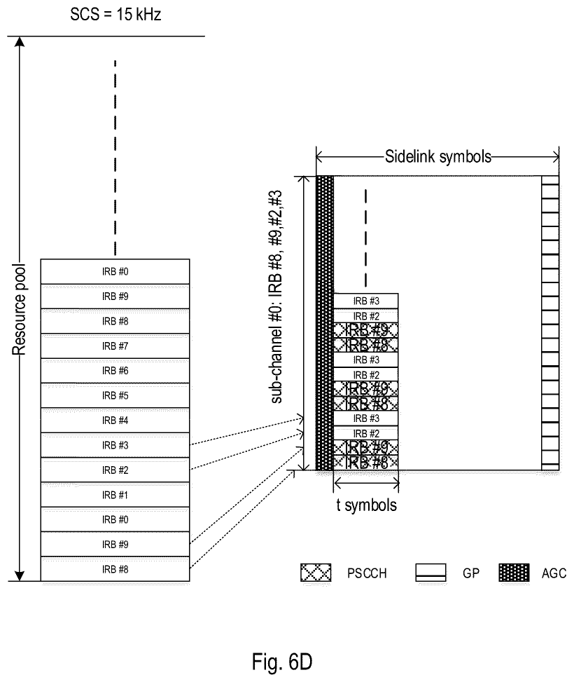

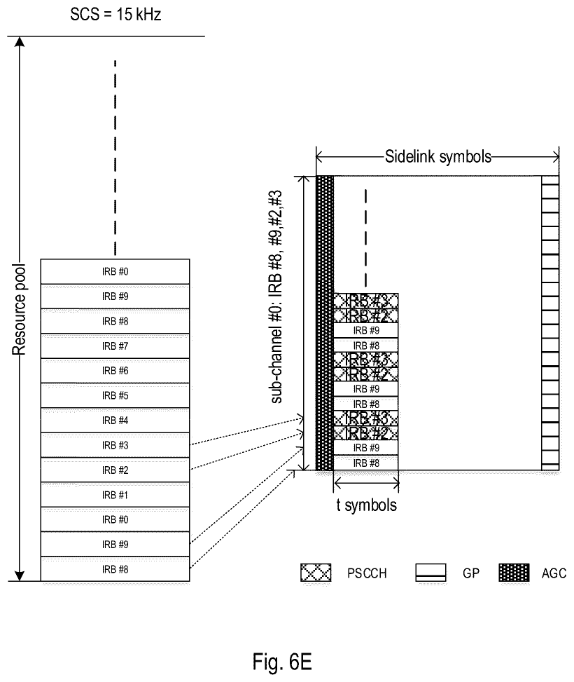

In some embodiments, the sub-channel resource comprises the second number of interlaces, and the second number may be equal to the first number. This will be described with reference to FIG. 6A.

FIG. 6A illustrates an example of a sidelink control channel resource in accordance with some embodiments of the present disclosure. In the example of FIG. 6A, SCS is 15 kHz, the number of sub-channel resources is equal to 10. Within a resource pool (or an RB set), a sub-channel resource (also referred to as “sub-channel” for brevity) #0 contains RB #[m, m+10, . . . , m+90] in one IRB (i.e., k=1). A PSCCH resource (also referred to as “PSCCH” for brevity) comprises all the RBs in the sub-channel resource #0. This example provides basic frequency resource allocation for PSCCH based on IRB and directly mapping relationship between PSCCH and sub-channel is provided.

In some embodiments, the sub-channel resource comprises the second number of interlaces, the first number is equal to one and the sidelink control channel resource comprises a starting interlace among the second number of interlaces. This will be described with reference to FIG. 6B.

FIG. 6B illustrates an example of a sidelink control channel resource in accordance with some embodiments of the present disclosure. In the example of FIG. 6B, SCS is 30 kHz. Within a resource pool, a sub-channel resource #0 contains RBs in IRBs #3 and #2 (i.e., k=2). A PSCCH resource comprises all the RBs in a starting IRB (i.e., the IRB #3) of the sub-channel resource #0.

In some embodiments, the sub-channel resource comprises the second number of interlaces, the first number is equal to one and the sidelink control channel resource comprises a lowest interlace among the second number of interlaces. This will be described with reference to FIG. 6C.

FIG. 6C illustrates an example of a sidelink control channel resource in accordance with some embodiments of the present disclosure. In the example of FIG. 6C, SCS is 30 kHz. Within a resource pool, a sub-channel resource #0 contains RBs in IRBs #3 and #2 (i.e., k=2). A PSCCH resource comprises all the RBs in a lowest interlace (i.e., the IRB #2) of the sub-channel resource #0.

In some embodiments, the sub-channel resource comprises the second number of interlaces, the first number is equal to or greater than one and the sidelink control channel resource comprises the first number of logically consecutive interlaces starting from a starting interlace among the second number of interlaces. This will be described with reference to FIG. 6D.

FIG. 6D illustrates an example of a sidelink control channel resource in accordance with some embodiments of the present disclosure. In the example of FIG. 6D, SCS is 15 kHz. Within a resource pool, a sub-channel resource #0 contains RBs in IRBs #8, #9, #2 and #3 (i.e., k=4). A PSCCH resource comprises all the RBs in two IRBs (i.e., n=2) starting from the starting IRB (i.e., the IRB #8) of the sub-channel resource #0.

In some embodiments, the sub-channel resource comprises the second number of interlaces, the first number is equal to or greater than one and the sidelink control channel resource comprises the first number of logically consecutive interlaces starting from a lowest interlace among the second number of interlaces. This will be described with reference to FIG. 6E.

FIG. 6E illustrates an example of a sidelink control channel resource in accordance with some embodiments of the present disclosure. Similar to the example of FIG. 6D, in the example of FIG. 6E, SCS is 15 kHz and a sub-channel resource #0 contains RBs in IRBs #8, #9, #2 and #3 (i.e., k=4). Different from the example of FIG. 6D, in the example of FIG. 6E, a PSCCH resource comprises all the RBs in two IRBs starting from the lowest IRB (i.e., the IRB #2) of the sub-channel resource #0. This example uses the lowest index IRB in a sub-channel as the PSCCH and provides another rule for defining the location of PSCCH.

In addition, in the examples of FIGS. 6A to 6E, in time domain, one AGC symbol may be set before the PSCCH resource, i.e., AGC is allocated on the first sidelink symbol, and the PSCCH resource comprises t consecutive symbols starting from the second sidelink symbol.

In some embodiments, the sidelink control channel resource comprises the first number of RBs, and the first number of RBs are comprised in a corresponding sub-channel resource. In other words, the sidelink control channel resource is defined within one sub-channel and uses RB as frequency resource unit.

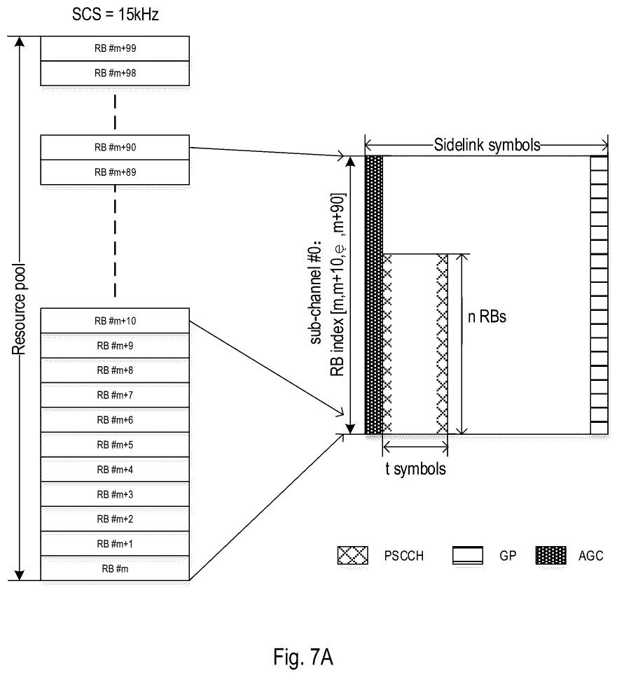

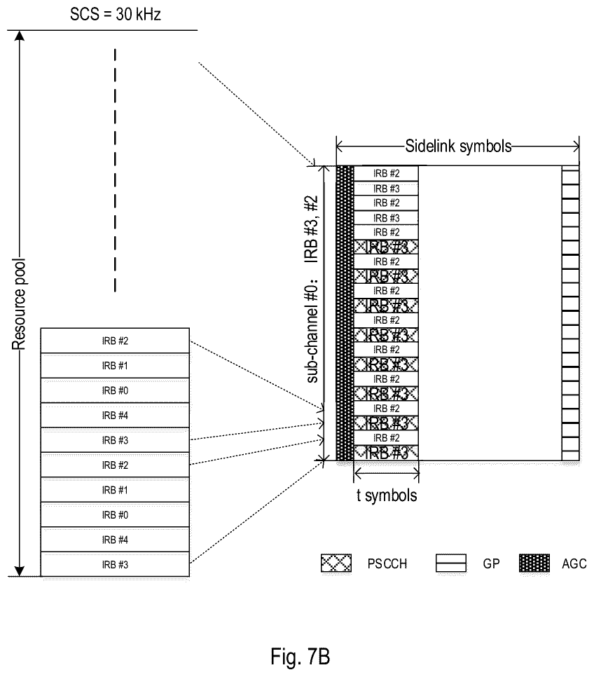

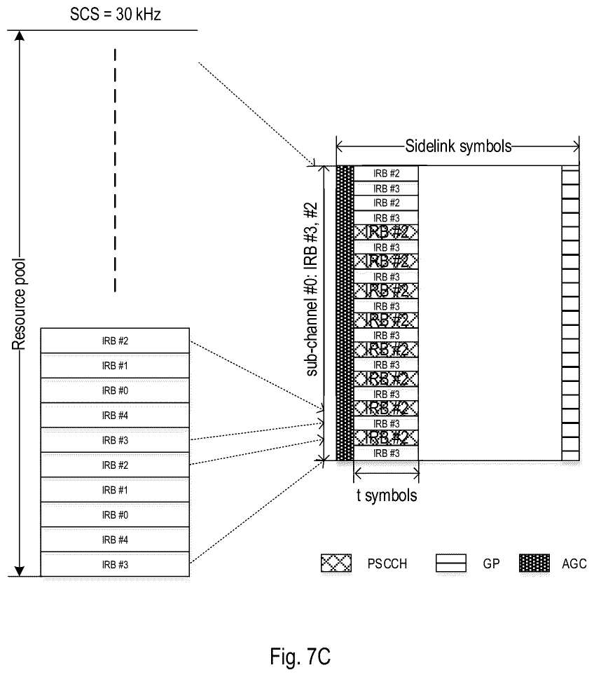

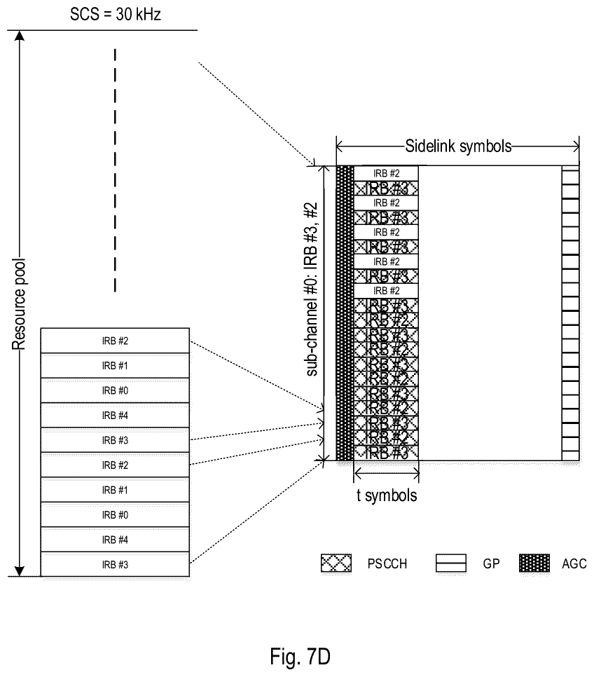

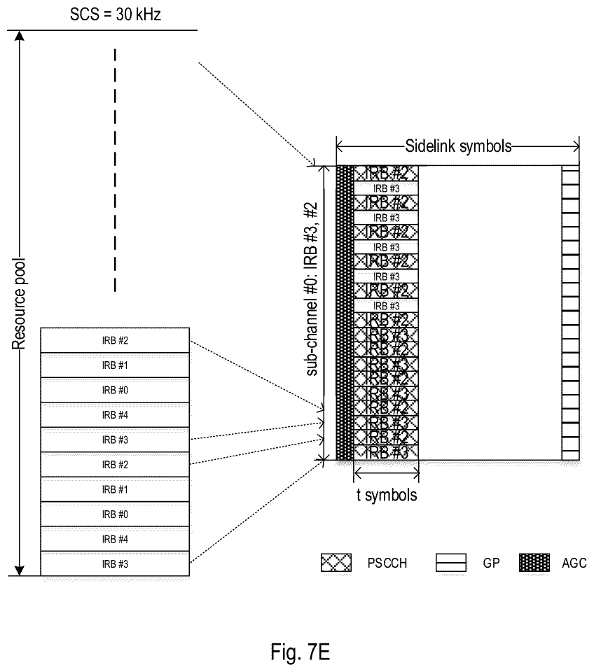

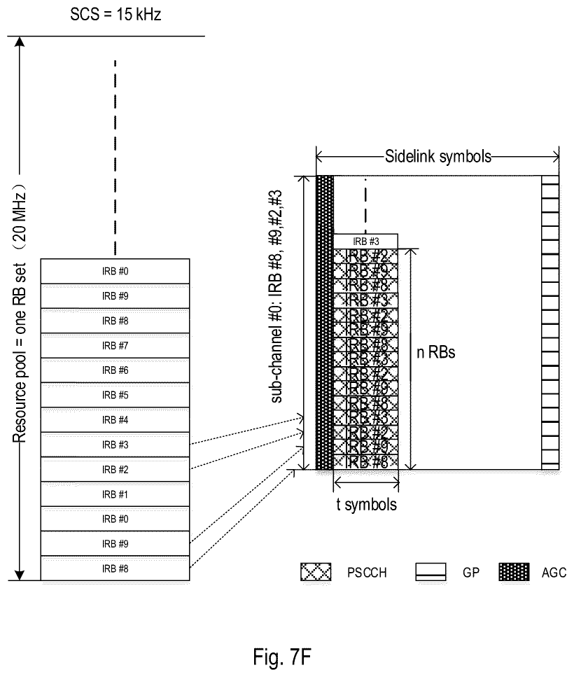

In some embodiments, the sub-channel resource comprises a single interlace, and the sidelink control channel resource comprises the first number of logically consecutive RBs starting from a lowest RB of the single interlace. This will be described with reference to FIG. 7A.

FIG. 7A illustrates an example of a sidelink control channel resource in accordance with some embodiments of the present disclosure. In the example of FIG. 7A, SCS is 15 kHz. Within a resource pool, a sub-channel resource #0 contains RB #[m, m+10, . . . , m+90] in an IRB (i.e., k=1). A PSCCH resource comprises logical consecutive n RBs within the sub-channel resource #0 or the IRB. The logical consecutive n RBs starts from the lowest RB of the sub-channel resource #0, where n<=IRB size=sub-channel size, where IRB size represents the number of RBs comprised in an interlace, sub-channel size represents the number of RBs comprised in a sub-channel. This example provides more flexibility of assigning a number of RBs for PSCCH.

In some embodiments, the sub-channel resource comprises the second number of interlaces, the sidelink control channel resource comprises the first number of logically consecutive RBs starting from a lowest RB, and the lowest RB is comprised in a starting interlace among the second number of interlaces. In some embodiments, the starting interlace comprises a fourth number of RBs, and the first number is equal to or less than the fourth number. This will be described with reference to FIG. 7B.

FIG. 7B illustrates an example of a sidelink control channel resource in accordance with some embodiments of the present disclosure. In the example of FIG. 7B, SCS is 30 kHz. Within a resource pool, a sub-channel resource #0 contains RBs in IRBs #3 and #2 (i.e., k=2). A PSCCH resource comprises logical consecutive n RBs within the starting IRB (i.e., IRB #3) of the sub-channel resource #0. The logical consecutive n RBs starts from the lowest RB within the starting IRB, where n<=IRB size=10 (in the example of FIG. 7B, n=8). This example provides more flexibility of assigning a number of RBs for PSCCH.

In some embodiments, the sub-channel resource comprises the second number of interlaces, the sidelink control channel resource comprises the first number of logically consecutive RBs starting from a lowest RB, and the lowest RB is comprised in a lowest interlace among the second number of interlaces. In some embodiments, the lowest interlace comprises a fourth number of RBs, and the first number is equal to or less than the fourth number. This will be described with reference to FIG. 7C.

FIG. 7C illustrates an example of a sidelink control channel resource in accordance with some embodiments of the present disclosure. Similar to the example of FIG. 7B, in the example of FIG. 7C, SCS is 30 kHz and a sub-channel resource #0 contains RBs in IRBs #3 and #2 (i.e., k=2). Different from the example of FIG. 7B, in the example of FIG. 7C, a PSCCH resource comprises logical consecutive n RBs within the lowest IRB (i.e., IRB #2) of the sub-channel resource #0. The logical consecutive n RBs starts from the lowest RB within the lowest IRB, where n<=IRB size=10 (in the example of FIG. 7C, n=8). This example provides another rule for defining the location of PSCCH.

In some embodiments, the sub-channel resource comprises the second number of interlaces, the second number is greater than one, the first number is greater than the fourth number (i.e., the number of RBs in the lowest interlace or the starting interlace) and less than or equal to a total number of RBs in the second number of interlaces. In such embodiments, the sidelink control channel resource comprises the first number of RBs from a lowest RB of a first interlace. The first number of RBs are first in an increasing order of indexes of RBs of an interlace and then in an increasing order of indexes of interlaces comprised in the second number of interlaces. The first interlace comprises one of the following: a lowest interlace among the second number of interlaces, or a starting interlace among the second number of interlaces. This will be described with reference to FIGS. 7D and 7E.

FIG. 7D illustrates an example of a sidelink control channel resource in accordance with some embodiments of the present disclosure. In the example of FIG. 7D, SCS is 30 kHz. Within a resource pool, a sub-channel resource #0 contains RBs in IRBs #3 and #2 (i.e., k=2). A PSCCH resource comprises logical consecutive n RBs. The logical consecutive n RBs comprises RBs from a lowest RB of the starting interlace (i.e., IRB #3) of the sub-channel #0 and comprises all RBs of the starting interlace, and further comprises RBs from a lowest RB of an interlace (i.e., IRB #2) subsequent to the starting interlace. In the example of FIG. 7D, n=15, i.e., the PSCCH resource comprises all the RBs of the IRB #3 and part of RBs of IRB #2. This example provides more flexibility of assigning a number of RBs for PSCCH.

FIG. 7E illustrates an example of a sidelink control channel resource in accordance with some embodiments of the present disclosure. Similar to the example of FIG. 7D, in the example of FIG. 7E, SCS is 30 kHz, a sub-channel resource #0 contains RBs in IRBs #3 and #2 (i.e., k=2), and n=15. A PSCCH resource comprises logical consecutive n RBs. Different from the example of FIG. 7D, in the example of FIG. 7E, the logical consecutive n RBs comprises RBs from a lowest RB of the lowest interlace (i.e., IRB #2) of the sub-channel #0, and comprises all RBs of the lowest interlace, and further comprises RBs from a lowest RB of an interlace (i.e., IRB #3) subsequent to the lowest interlace.

In some embodiments, the sub-channel resource comprises the second number of interlaces, and the first number of RBs comprise the first number of logically consecutive RBs starting from a lowest RB among RBs comprised in the sub-channel. This will be described with reference to FIG. 7F.

FIG. 7F illustrates an example of a sidelink control channel resource in accordance with some embodiments of the present disclosure. In the example of FIG. 7F, SCS is 15 kHz. Within a resource pool, a sub-channel resource #0 contains RBs in IRBs #8, #9, #2 and #3 (i.e., k=4). A PSCCH resource comprises logical consecutive n RBs within the sub-channel resource #0. The logical consecutive n RBs start from a lowest RB among RBs comprised in the sub-channel resource #0. In the example of FIG. 7F, n=15. This example provides more flexibility of assigning a number of RBs for PSCCH.

In addition, in the examples of FIGS. 7A to 7F, in time domain, one AGC symbol may be set before the PSCCH resource, i.e., AGC is allocated on the first sidelink symbol, and the PSCCH resource comprises t consecutive symbols starting from the second sidelink symbol.

In some embodiments, for the case that sub-channel of SL-U is directly defined as one IRB, the PSCCH may need to use RBs across sub-channels to provide enough RBs for SCI bearing. In such embodiments, the sidelink control channel resource is defined across sub-channel resources and uses IRB as frequency resource unit. The terminal device 110 may determine a sidelink shared channel resource which is associated to the sidelink control channel resource. The sidelink shared channel resource comprises a fifth number of interlaces. The sidelink control channel resource may comprise the first number of interlaces among the fifth number of interlaces. In other words, in case where the fifth number is represented by N, 1<=n<=N. The terminal device 110 may determine the first number based on a list of available values for the first number. For example, as described above, the sidelink control channel resource configuration may indicate the list of available values for the first number.

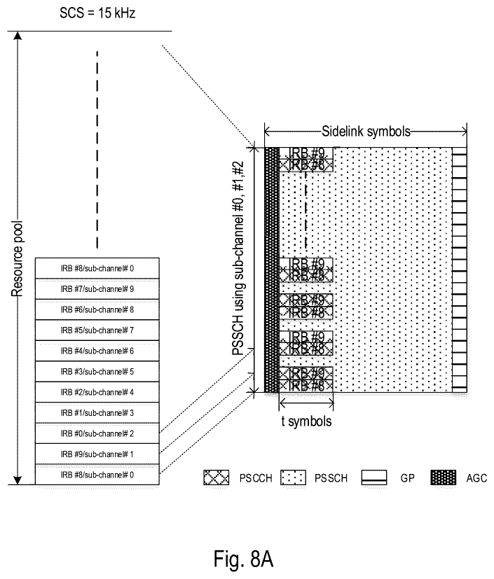

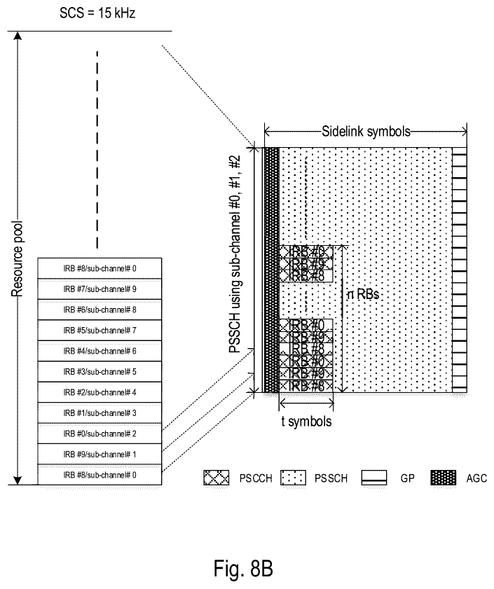

In such embodiments, the first number of interlaces may comprise the first number of logically consecutive interlaces starting from one of the following: a lowest interlace among the fifth number of interlaces, or a starting interlace among the fifth number of interlaces. This will be described with reference to FIG. 8A.

FIG. 8A illustrates an example of a sidelink control channel resource in accordance with some embodiments of the present disclosure. In the example of FIG. 8A, SCS is 15 kHz. A PSSCH resource which is associated to a PSCCH resource comprises sub-channel resources #0, #1 and #2 (i.e., N=3) within a resource pool. In other words, the PSSCH resource comprises IRBs #8, #9 and #0. The terminal device 110 may select n=2 within the list of available values for the first number. A PSCCH resource comprises logically consecutive two IRBs starting from a starting IRB (i.e., the IRB #8) among the IRBs #8, #9 and #0. That is, the PSCCH resource comprises the IRBs #8 and #9.

In embodiments where the sidelink control channel resource is defined across sub-channel resources and uses IRB as frequency resource unit, the sidelink control channel resource may comprise the first number of logically consecutive RBs comprised in the fifth number of interlaces for the sidelink shared channel resource. The terminal device 110 may determine the first number based on the list of available values for the first number. In such embodiments, the first number of logically consecutive RBs may start from one of the following: a lowest RB of the lowest interlace among the fifth number of interlaces, or a lowest RB of the starting interlace among the fifth number of interlaces. This will be described with reference to FIG. 8B.

FIG. 8B illustrates an example of a sidelink control channel resource in accordance with some embodiments of the present disclosure. Similar to the example of FIG. 8A, in the example of FIG. 8B, SCS is 15 kHz, and a PSSCH resource comprises IRBs #8, #9 and #0. The terminal device 110 may select n=15 within the list of available values for the first number. A PSCCH resource comprises logically consecutive n (i.e., fifteen) RBs starting from a lowest RB of a starting IRB (i.e., the IRB #8) among the IRBs #8, #9 and #0.

In addition, in the examples of FIGS. 8A and 8B, in time domain, one AGC symbol may be set before the PSCCH resource, i.e., AGC is allocated on the first sidelink symbol, and the PSCCH resource comprises t consecutive symbols starting from the second sidelink symbol.

In embodiments where the first number is determined based on a list of available values for the first number, in order to receive the sidelink control information on the sidelink control channel resource, the terminal device 110 may blindly detect the sidelink control information on the sidelink control channel resource with at least one of the available values for the first number.

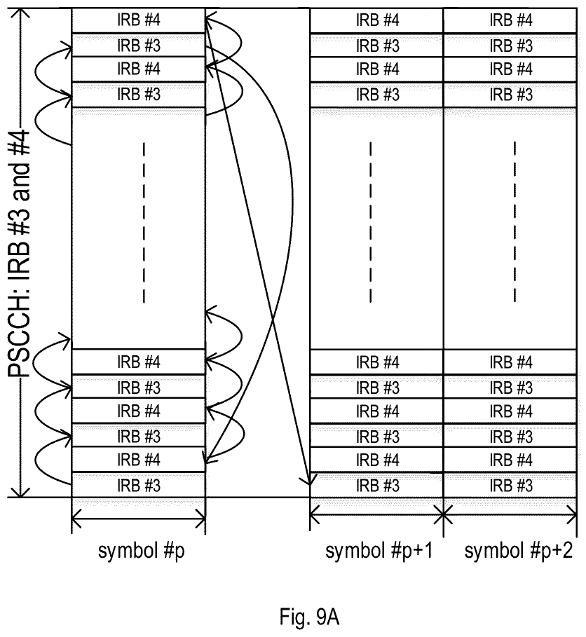

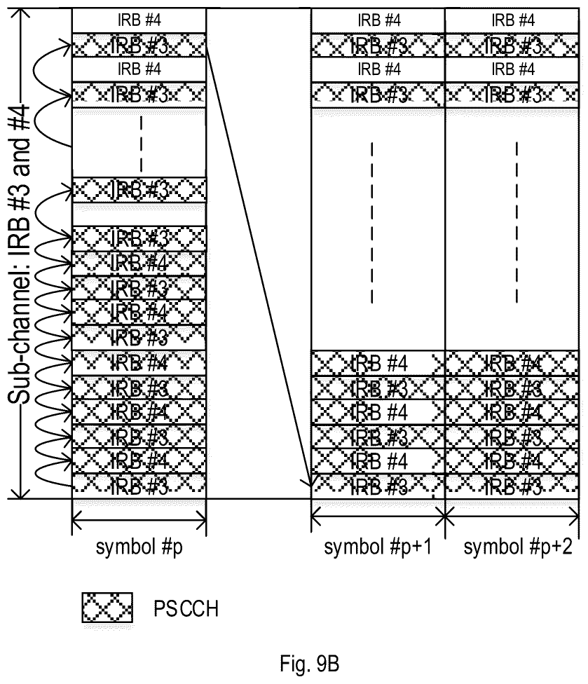

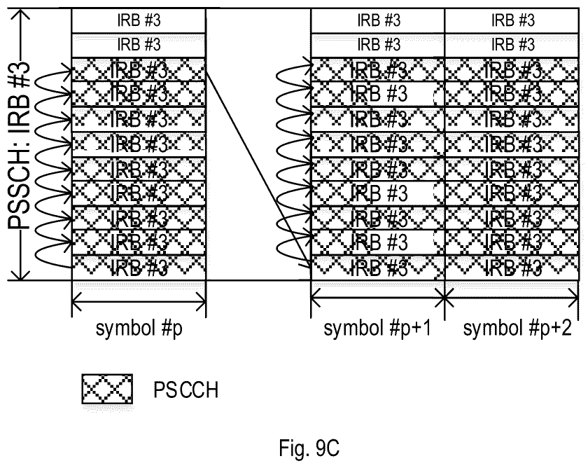

In embodiments where the sidelink control channel resource comprises the first number of interlaces, in order to transmit the sidelink control information on the sidelink control channel resource, the terminal device 110 may map the sidelink control information to RBs comprised in the first number of interlaces from a lowest RB of a first interlace. The terminal device 110 may map the sidelink control information to RBs comprised in the first number of interlaces first in an increasing order of indexes of RBs of an interlace and then in an increasing order of indexes of interlaces comprised in the sidelink control channel resource. The first interlace comprises one of the following: a lowest interlace among the first number of interlaces, or a starting interlace among the first number of interlaces. This will be described with reference to FIG. 9A.

FIG. 9A illustrates an example of mapping of SCI to a sidelink control channel resource in accordance with some embodiments of the present disclosure. In the example of FIG. 9A, n is equal to two, and a PSCCH resource comprises RBs in IRBs #3 and #4. In frequency domain, SCI is mapped to the PSCCH resource based on IRB. Specifically, the SCI is mapped to the IRBs #3 and #4 from a lowest RB of a lowest IRB (i.e., the IRB #3) in an increasing order of indexes of RBs comprised in IRB #3, and then mapped from a lowest RB of an interlace (i.e., the IRB #4) subsequent to the IRB #3 in an increasing order of indexes of RBs comprised in IRB #4.

In some embodiments, in order to transmit the sidelink control information on the sidelink control channel resource, the terminal device 110 may map the sidelink control information from a lowest RB in an increasing order of indexes of RBs comprised in the sidelink control channel resource. This will be described with reference to FIGS. 9B and 9C.

FIGS. 9B and 9C illustrate an example of mapping of SCI on a sidelink control channel resource in accordance with some embodiments of the present disclosure, respectively. In the example of FIG. 9B, a sub-channel resource comprises RBs in IRBs #3 and #4, and a PSCCH resource comprises 15 RBs in the IRBs #3 and #4. In other words, the PSCCH resource comprises all RBs in the IRB #3 and part of RBs in the IRB #4. In frequency domain, SCI is mapped to the PSCCH resource based on RB. Specifically, the SCI is mapped to RBs from a lowest RB in an increasing order of indexes of RBs comprised in the PSCCH resource.

In the example of FIG. 9C, a sub-channel resource comprises 11 RBs in an IRB #3, a PSSCH resource comprises 11 RBs in the IRB #3, and a PSCCH resource comprises 9 RBs starting from the lowest RB within the IRB #3. In frequency domain, SCI is mapped to the 9 RBs starting from the lowest RB within the IRB #3.

In some embodiments, the sidelink control information is mapped to symbols comprised in the sidelink control channel resource in an increasing order of indexes of the symbols. For example, as shown in FIGS. 9A to 9C, the PSCCH resource comprises symbols #p, #p+1 and #p+2, and the SCI is mapped first to RBs on a symbol #p, then to RBs on a symbol #p+1, and then to RBs on a symbol #p+2.

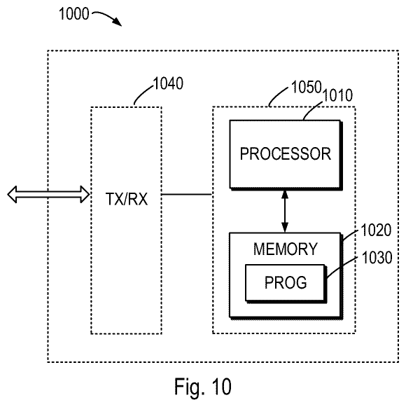

FIG. 10 is a simplified block diagram of a device 1000 that is suitable for implementing some embodiments of the present disclosure. The device 1000 can be considered as a further example embodiment of one of the terminal devices 110, 120 and 130 or the network device 140 or 150 as shown in FIG. 1. Accordingly, the device 1000 can be implemented at or as at least a part of one of the terminal devices 110, 120 and 130 or the network device 140 or 150.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 10. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method for communications, comprising:
determining, at a terminal device, a sidelink control channel resource based on sidelink resource configuration information, the sidelink control channel resource comprising a first number of frequency resource units, each of the frequency resource units being a resource block (RB) or interlace; and
transmitting or receiving sidelink control information on the sidelink control channel resource.

2. The method of claim 1, wherein the sidelink resource configuration information comprises at least one of the following:
a sub-channel resource configuration, or
a sidelink control channel resource configuration.

3. The method of claim 2, further comprising:
obtaining the sidelink resource configuration information from at least one of following:
pre-definition,
configuration, or
pre-configuration.

4. The method of claim 2, wherein the sidelink control channel resource configuration is for at least one of the following:
a sidelink resource pool,
a sidelink bandwidth part (BWP),
a sidelink carrier, or
an RB set.

5. The method of claim 2, wherein the sub-channel resource configuration indicates at least one of following:
a second number of interlaces comprised in a sub-channel resource, or
an index of at least one of the second number of interlaces comprised in the sub-channel.

6. The method of claim 2, wherein the sidelink control channel resource configuration indicates at least one of the following:
an interlace enablement indication which indicates using interlace as frequency domain resource unit for the sidelink control channel resource,
a frequency domain resource unit indication which indicates using interlace or RB as frequency domain resource unit for the sidelink control channel resource,
the first number,
a list of available values for the first number,
a third number, the sidelink control channel resource comprising the third number of symbols within a slot, or
a frequency domain location indication of the sidelink control channel resource.

7. The method of claim 6, wherein the frequency domain location indication indicates one of the following:
the sidelink control channel resource starts from a lowest interlace in a corresponding sub-channel resource,
the sidelink control channel resource starts from a starting interlace in the corresponding sub-channel resource,
the sidelink control channel resource starts from a lowest RB of the lowest interlace in the corresponding sub-channel resource, or
the sidelink control channel resource starts from a lowest RB of the starting interlace in the corresponding sub-channel resource.

8. The method of claim 2, wherein the sidelink resource configuration information indicates:
an interlace enablement indication which indicates using interlace as frequency domain resource unit for sidelink transmission.

9. The method of claim 1, wherein the sidelink control channel resource comprises the first number of interlaces, the first number of interlaces being comprised in a corresponding sub-channel resource.

10. The method of claim 9, wherein the sub-channel resource comprises a second number of interlaces, the second number being equal to the first number.

11. The method of claim 9, wherein the sub-channel resource comprises a second number of interlaces, the first number being equal to one; and
wherein the sidelink control channel resource comprises one of the following:
a lowest interlace among the second number of interlaces, or
a starting interlace among the second number of interlaces.

12. The method of claim 9, wherein the sub-channel resource comprises a second number of interlaces, the first number being equal to or greater than one; and
wherein the sidelink control channel resource comprises the first number of logically consecutive interlaces start from one of the following:
a lowest interlace among the second number of interlaces, or
a starting interlace among the second number of interlaces.

13. The method of claim 1, wherein the sidelink control channel resource comprises the first number of RBs, the first number of RBs being comprised in a corresponding sub-channel resource.

14. The method of claim 13, wherein the sub-channel resource comprises a single interlace; and
wherein the sidelink control channel resource comprises the first number of logically consecutive RBs starting from a lowest RB of the single interlace.

15. The method of claim 13, wherein the sub-channel resource comprises a second number of interlaces, and
wherein the sidelink control channel resource comprises the first number of logically consecutive RBs starting from a lowest RB, the lowest RB being comprised in one of the following:
a lowest interlace among the second number of interlaces, or
a starting interlace among the second number of interlaces.

16. The method of claim 15, wherein the lowest interlace or the starting interlace comprises a fourth number of RBs, and the first number is equal to or less than the fourth number.

17. The method of claim 13, wherein the sub-channel resource comprises a second number of interlaces, and
wherein the sidelink control channel resource comprises the first number of RBs from a lowest RB of a first interlace, and the first number of RBs are first in an increasing order of indexes of RBs of an interlace and then in an increasing order of indexes of interlaces comprised in the second number of interlaces, and
wherein the first interlace comprises one of the following:
a lowest interlace among the second number of interlaces, or
a starting interlace among the second number of interlaces.

18. The method of claim 13, wherein the sub-channel resource comprises a second number of interlaces, and
wherein the sidelink control channel resource comprises the first number of logically consecutive RBs starting from a lowest RB among RBs comprised in the sub-channel.

19. The method of claim 1, further comprising:
determining a sidelink shared channel resource which is associated to the sidelink control channel resource, the sidelink shared channel resource comprising a fifth number of interlaces; and
wherein the sidelink control channel resource comprises the first number of interlaces among the fifth number of interlaces.

20. The method of claim 19, wherein the sidelink control channel resource comprises the first number of logically consecutive interlaces starting from one of the following:
a lowest interlace among the fifth number of interlaces, or
a starting interlace among the fifth number of interlaces.

21. The method of claim 1, further comprising:
determining a sidelink shared channel resource which is associated to the sidelink control channel resource, the sidelink shared channel resource comprising a fifth number of interlaces, and
wherein the sidelink control channel resource comprises the first number of logically consecutive RBs comprised in the fifth number of interlaces.

22. The method of claim 21, wherein the first number of logically consecutive RBs start from one of the following:
a lowest RB of the lowest interlace among the fifth number of interlaces, or
a lowest RB of the starting interlace among the fifth number of interlaces.

23. The method of claim 19 or 21, further comprising:
determining the first number based on a list of available values for the first number.

24. The method of claim 23, wherein receiving the sidelink control information on the sidelink control channel resource comprises:
blindly detecting the sidelink control information on the sidelink control channel resource with at least one of the available values for the first number.

25. The method of claim 1, wherein the sidelink control channel resource comprises the first number of interlaces; and
wherein transmitting the sidelink control information on the sidelink control channel resource comprises:
mapping the sidelink control information to RBs comprised in the first number of interlaces from a lowest RB of a first interlace, and first in an increasing order of indexes of RBs of an interlace and then in an increasing order of indexes of interlaces comprised in the sidelink control channel resource, and
wherein the first interlace comprises one of the following:
a lowest interlace among the first number of interlaces, or
a starting interlace among the first number of interlaces.

26. The method of claim 1, wherein transmitting the sidelink control information on the sidelink control channel resource comprises:
mapping the sidelink control information from a lowest RB in an increasing order of indexes of RBs comprised in the sidelink control channel resource.

27. The method of claim 25 or 26, wherein transmitting the sidelink control information on the sidelink control channel resource comprises:
mapping the sidelink control information to symbols comprised in the sidelink control channel resource in an increasing order of indexes of the symbols.

28. A terminal device, comprising:
a processor; and
a memory coupled to the processor and storing instructions thereon, the instructions, when executed by the processor, causing the terminal device to perform the method according to any of claims 1-27.

29. A computer readable medium having instructions stored thereon, the instructions, when executed on at least one processor of a device, causing the device to carry out the method according to any of claims 1-27.
